(19) United States
(12) Patent Application Publication
(10) Pub. No.: US 2007/0114911 A1
(43) Pub. Date: May 24, 2007

(54) Electron emission device, electron emission display device using the same, and method for manufacturing the same

(76) Inventor: Kyung-Sun Ryu, Yongin-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/582,617

(22) Filed: Oct. 17, 2006

(30) Foreign Application Priority Data
Oct. 21, 2005 (KR) 10-2005-0099632

(51) Int. Cl. H01J 1/18; H01J 19/42; H01J 9/02; H01J 63/04

(52) U.S. Cl. 313/495; 313/292; 313/238; 313/310

(57) ABSTRACT

An electron emission device is disclosed. The electron emission device includes an insulating layer that electrically insulates gate and cathode electrodes. The insulating layer includes first and second insulating portions. An opening is formed in the second insulating portion and is blocked by the first insulating portion. An electron emission unit is located in the opening and is configured to electrically connect the cathode electrode.

### CROSS-REFERENCE TO RELATED APPLICATION

This application claims priority to Korean patent application No. 2005-0099632 filed in the Korean Intellectual Property Office on Oct. 21, 2005, and all the benefits accruing therefrom under 35 U.S.C.§119, the contents of which is herein incorporated by reference in their entirety.

### BACKGROUND

1. Field of the Invention

The present invention relates to an electron emission device, an electron emission display device using the same, and method of manufacturing the same.

2. Description of the Related Technology

Generally, a hot or cold cathode can be used as an electron emission source in an electron emission device. There are several types of cold cathode electron emission devices, such as a field emitter array (FEA) electron emission device, a surface conduction emission (SCE) electron emission device, a metal-insulator-metal (MIM) electron emission device, a metal-insulator-semiconductor (MIS) electron emission device, and so on.

Among these electron emission devices, the FEA electron emission device includes cathode and gate electrodes as driving electrodes for controlling electron emission units and emission of electrons thereof. Materials having a low work function or a high aspect ratio are used for constituting an electron emission unit in the FEA electron emission device. For example, carbon-based materials such as carbon nanotubes, graphite, and diamond-like carbon have been developed to be used in an electron emission unit in order for electrons to be easily emitted by an electrical field in a vacuum.

The plurality of electron emission units are arrayed on a substrate to form an electron emission device, and the electron emission device is combined with another substrate on which phosphors and anode electrodes are formed to produce an electron emission display device.

### SUMMARY OF CERTAIN INVENTIVE ASPECTS

One aspect of the present invention provides an electron emission device including i) a substrate, ii) a cathode electrode located on the substrate, iii) an insulating layer, iv) a gate electrode located on the insulating layer, and v) an electron emission unit located in the opening and configured to electrically connect to the cathode electrode. The insulating layer includes i) a first insulating portion located on the substrate while covering the cathode electrode, and ii) a second insulating portion located on the first insulating portion and having an opening that is blocked by the first insulating portion.

The first insulating portion may have a via hole located below the opening, and a conductive member may be provided in the via hole such that the electron emission unit is configured to be electrically connected to the cathode electrode through the conductive member. A contacting surface of the opening and the via hole may be surrounded by a contacting surface of the electron emission unit and the first insulating portion. A contacting surface of the opening and the via hole may be included in a contacting surface of the electron emission unit and the opening. The diameter of the via hole may be less than the diameter of the opening. A main material included in the conductive member may be the same as a main material included in the electron emission unit.

The electron emission unit may be located on the first insulating portion. The etching rate of the second insulating portion may be greater than the etching rate of the first insulating portion, and the etching rate may be proportional to an amount of a material commonly included in the first and second insulating portions. The material may include B₂O₃.

The distance between the electron emission unit and an imaginary plane extending from the gate electrode in a direction to be substantially parallel to the cathode electrode may be substantially equal to or shorter than the distance between the cathode electrode and the electron emission unit.

Another aspect of the present invention provides an electron emission display device including i) opposing first and second substrates, ii) a cathode electrode located on the first substrate, iii) an insulating layer, iv) a gate electrode located on the insulating layer, v) an electron emission unit located in the opening and configured to electrically connect to the cathode electrode, vi) a phosphor layer located on the second substrate, and vii) an anode electrode located on the second substrate. The insulating layer includes i) a first insulating portion located on the substrate while covering the cathode electrode, and ii) a second insulating portion located on the first insulating portion and having an opening that is blocked by the first insulating portion.

The first insulating portion may have a via hole below the opening. A conductive member may be provided in the via hole such that the electron emission unit is configured to electrically connect to the cathode electrode through the conductive member.

Still another aspect of the present invention provides a method of manufacturing an electron emission device including i) providing a substrate, ii) providing a cathode electrode on the substrate, iii) providing a first insulating portion on the substrate while covering the cathode electrode, iv) providing a via hole in the first insulating portion such that the cathode electrode is exposed through the via hole, v) providing a second insulating portion on the first insulating portion, vi) providing a conductive layer on the second insulating portion, vii) providing openings in the conductive layer and the second insulating portion, respectively, such that the via hole is exposed through the openings, viii) patterning the conductive layer such that a gate electrode is formed, and ix) providing an electron emission unit on the first insulating portion while filling the via hole with a conductive member.

The opening of the second insulating portion and the via hole of the first insulating portion may be provided by etching. The etching rate of the first insulating portion may be lower than the etching rate of the second insulating portion, and the etching rate may be proportional to the amount of a material commonly included in the first and second insulating portions. The electron emission unit may be formed to extend from the conductive member, and it may be electrically connected to the cathode electrode through the conductive member. The first and second insulating portions may be provided by a printing method.

### BRIEF DESCRIPTION OF THE DRAWINGS

FIG. 1 is a partial exploded perspective view of the electron emission device in accordance with an embodiment.

FIG. 2 is a partial cross-sectional view of the electron emission device of FIG. 1.

FIG. 3 is a partial cross-sectional view of the electron emission display device including the electron emission device of FIG. 1.

FIGS. 4A to 4F are schematic cross-sectional views for illustrating each step of manufacturing the electron emission device in accordance with an embodiment.

### DETAILED DESCRIPTION OF CERTAIN INVENTIVE EMBODIMENTS

With reference to the accompanying drawings, embodiments of the present invention will be described in order for those skilled in the art to be able to implement it. As those skilled in the art would realize, the described embodiments may be modified in various different ways, all without departing from the spirit or scope of the present invention. Wherever possible, the same reference numbers will be used throughout the drawings to refer to the same or like parts.

It will be understood that when an element is referred to as being “on” another element, it can be directly on the other element or intervening elements may be present there between. In contrast, when an element is referred to as being “directly on” another element, there are no intervening elements present.

It will be understood that, although the terms first, second, third, etc., may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present invention.

The terminology used herein is for the purpose of describing particular embodiments only and is not intended to limit the scope of the invention. As used herein, the singular forms “a”, “an”, and “the” are intended to include the plural forms as well, unless the context clearly indicates otherwise. It will be further understood that the terms “comprises” and/or “comprising” or “includes” and/or “including” when used in this specification specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper”, “over”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross-sectional illustrations that are schematic illustrations of embodiments of the present invention. As such, variations from the shapes of the illustrations as a result of manufacturing techniques and/or tolerances, for example, are to be expected. Thus, embodiments should not be construed to limit the invention to the particular shapes of regions illustrated herein but are to include deviations in shapes that result, for example, from manufacturing. For example, a region illustrated or described as flat may typically have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

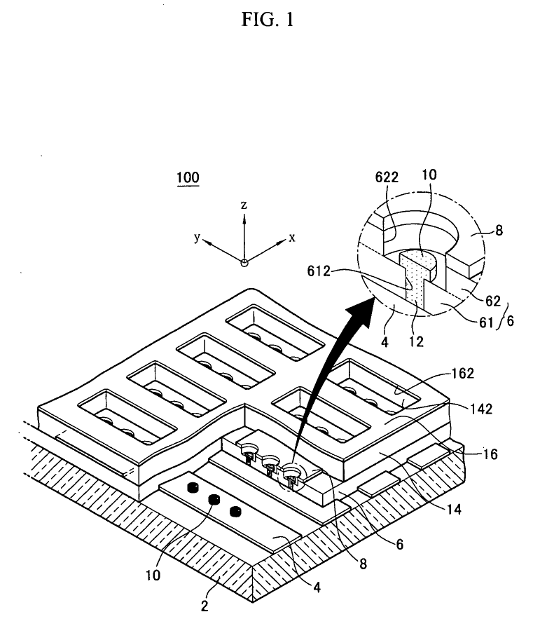

FIG. 1 illustrates a partial exploded perspective view of the electron emission device 100 in accordance with an embodiment.

As illustrated in FIG. 1, the electron emission device 100 includes a substrate 2, a plurality of cathode electrodes 4, an insulating layer 6, a plurality of gate electrodes 8, another insulating layer 14, a focusing electrode 16, and a plurality of electron emitting units 10. Although not illustrated in FIG. 1, other elements may be further included in the electron emission device 100, if necessary.

The plurality of cathode electrodes 4 are formed on the substrate 2 in a stripe pattern, and extend in a y-axis direction. The insulating layer 6 is located on the substrate 2 while covering the cathode electrodes 4. The plurality of gate electrodes 8 are formed on the insulating layer 6 in a stripe pattern, and extend in an x-axis direction crossing an extending direction of the plurality of cathode electrodes 4.

The electron emission unit 10 includes materials that are capable of emitting electrons, such as carbon-based or nanometer-sized materials, when an electric field is formed in a vacuum atmosphere. The electron emitting unit 10 may include, for example, carbon nanotubes, graphite, graphite nanofibers, diamond, diamond-like carbon, C₆₀, silicon nanowire, and combinations thereof. The electron emission unit 10 may have a sharp tip and be mainly made of, for example, molybdenum, silicon, and so on.

In one embodiment, as illustrated in FIG. 1, the electron emission unit 10 has a cylindrical shape. The plurality of electron emission units 10 are arranged in a longitudinal direction of the cathode electrode 4. In addition, three electron emission units 10 correspond to one subpixel. However, the shape, number per subpixel, and arrangement of the electron emission units are not limited to illustrations in FIG. 1.

The insulating layer 6 is located between the cathode electrode 4 and the gate electrode 8 in order to prevent them from electrically being connected, thus forming a short circuit. Another insulating layer 14 is also located between the gate electrode 8 and the focusing electrode 16 for the same reason. Openings 142 and 162 are provided in another insulating layer 14 and the focusing electrode 16, respectively. Then, electron beams emitted from the electron emission unit 10 pass through the openings 142 and 162. As a result, electrons emitted from the electron emission unit 10 are focused well.

An enlarged circle of FIG. 1 illustrates a region including the electron emission unit 10. A boundary between the first and second insulating portions 61 and 62 is denoted as a dotted line.

As illustrated in the enlarged circle of FIG. 1, the insulating layer 6 includes first and second insulating portions 61 and 62. The first insulating portion 61 directly contacts and covers the cathode electrode 4, and the second insulating portion 62 is located on the first insulating portion 61.

A via hole 612 is formed in the first insulating portion 61, and is located below an opening 622. The opening 622 is formed in the second insulating portion 62, and is blocked by the first insulating portion 61 on its bottom surface. The electron emission unit 10 is located in the opening 622 and on the first insulating portion 61.

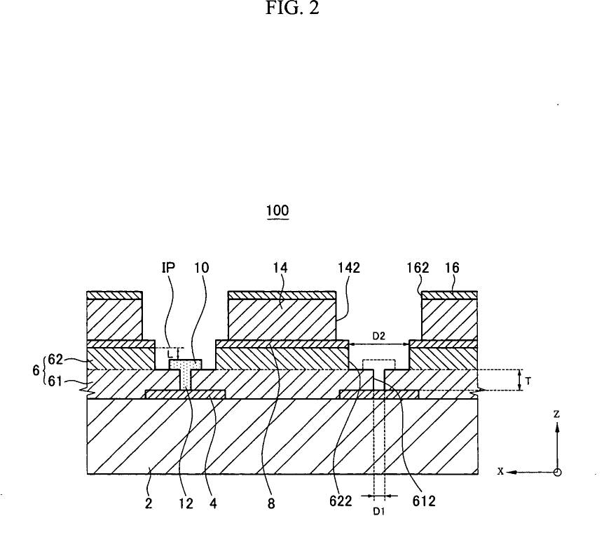

In one embodiment, a conductive member 12 is provided in the via hole 612, and contacts the cathode electrode 4 and the electron emission unit 10 as shown in FIGS. 1 and 2. Therefore, the electron emission unit 10 is electrically connected to the cathode electrode 4 through the conductive member 12.

Although the electron emission unit 10 is illustrated to be electrically connected to the cathode electrode 4 through the conductive member 12 in FIG. 1, this is merely an embodiment and the present invention is not limited thereto. Therefore, the electron emission unit 10 may be electrically connected to the cathode electrode 4 by using other methods. In one embodiment, the electron emission unit 10 and the conductive member 12 may be integrally formed. In another embodiment, the electron emission unit 10 does not include a separate conductive member. In this embodiment, the unit 10 includes a body portion located in the via hole 612 and a head portion extending from the body portion and located on the first insulating portion 61. The body portion may be formed of a conductive material and contact the head portion and the cathode electrode 4 on both sides thereof.

FIG. 2 illustrates a partial cross-sectional view of the electron emission device 100 of FIG. 1.

In one embodiment, as illustrated in FIG. 2, the electron emission unit 10 is formed to cover the via hole 612 and the first insulating portion 61 around the via hole 612. Then, a contacting surface of the opening 622 and the via hole 612 is surrounded by a contacting surface of the electron emission unit 10 and the first insulating portion 61. In one embodiment, since the electron emission unit 10 maintains a valid surface area such that a necessary amount of emitted electrons are sufficiently secured, its cross-sectional area is formed to be larger than the diameter D1 of the via hole 612.

In one embodiment, the diameter D1 may be minimized. In one embodiment, the opening 622 is designed to have a diameter D2 that can house the electron emission unit 10 therein and expose it. The diameter D2 may be maximized to enlarge a surface area of the electron emission unit 10. In this embodiment, the diameter D1 of the via hole 612 is less than the diameter D2 of the opening 622.

In FIG. 2, reference letter L is defined as the distance between the electron emission unit 10 and an imaginary plane IP. The imaginary plane IP extends from the gate electrode 8 in the x-axis direction. The x-axis direction is substantially parallel to the cathode electrode 4. Since the electron emission unit 10 is located on the first insulating portion 61, the distance L is reduced compared to the conventional device where the electron emission unit 10 is located on the cathode electrode 4 without the use of the conductive member 12.

In a conventional electron emission device, a printing method has been used for forming an insulating layer between the gate and cathode electrodes. The thickness of the insulating layer manufactured by the printing method should be at least 10.0 μm in order to maintain a withstand voltage for preventing the cathode and gate electrodes from being short circuited. Therefore, the distance between the electron emission unit and the gate electrode is long due to the thickness and then the driving voltage difference between the cathode and the gate electrodes is caused to increase.

In one embodiment, since the distance L is reduced in an embodiment, the driving voltage difference may be reduced. Accordingly, a diameter of the electron beam emitted from the electron emission unit 10 may be reduced and the electron beam may be focused well. In addition, the life span of the electron emission device 100 increases.

Reference letter T is defined as the thickness of the first insulating portion 61. The reference letter T is also defined as the distance between the cathode electrode 4 and the electron emission unit 10. The distance L is substantially equal to or shorter than the distance T.

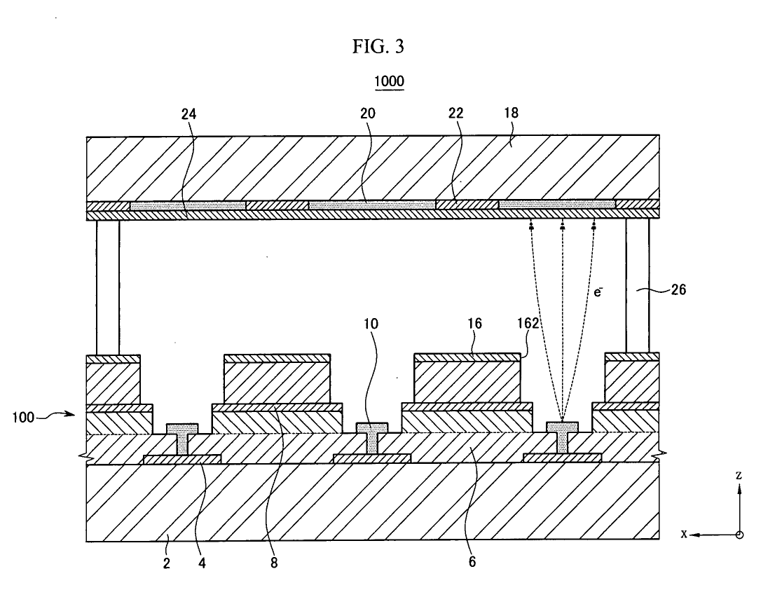

FIG. 3 illustrates a partial cross-sectional view of the electron emission display device 1000 including the electron emission device 100 of FIG. 1.

As illustrated in FIG. 3, the electron emission display device 1000 includes first and second substrates 2 and 18 facing each other. The first and second substrates 2 and 18 are located to be parallel to each other with a predetermined distance therebetween. A sealing member (not shown) is located on edges of the first and second substrates 2 and 18 such that they maintain the predetermined distance. The internal space surrounded by the two substrates 2 and 18 and the sealing member is evacuated to approximately 10⁻⁶ torr to form a vacuum vessel. The electron emission device 100 is assembled with the second substrate 18 and together they constitute the electron emission display device 1000. In one embodiment, the electron emission display device 1000 may emit light to a non-self emissive display device such as LCD. In this embodiment, the non-self emissive display device may use the received light as a back light source.

In one embodiment, phosphor layers 20, for example, red, green, and blue phosphor layers are formed to be spaced apart from each other on the second substrate 18. Black layers 22 are formed between each of the phosphor layers 20 in order to absorb ambient light. Each phosphor layer 20 corresponds to a subpixel area where an electron emission unit 10 is located.

Anode electrodes 24 made of, for example, a metallic film such as aluminum are formed on the phosphor layers 20 and the black layers 22. External high voltages, which are enough to accelerate electron beams, are applied to the anode electrodes 24 and then the phosphor layers 20 are maintained at high electric potentials by the anode electrodes 24. Among the visible rays emitted from the phosphor layers 20, visible rays directed to the first substrate 2 are reflected toward the second substrate 18 by the anode electrodes 24, and thereby brightness is enhanced.

In another embodiment, anode electrodes may be made of, for example, a transparent conductive film such as indium tin oxide (ITO). In this case, the anode electrode may be located between the second substrate and the phosphor layers. In addition, the transparent conductive films and metallic films may be formed together as an anode electrode.

Spacers 26 are located between the two substrates 2 and 18, thereby supporting the two substrates 2 and 18 against compressing force applied to a vacuum space therebetween. The spacers 26 uniformly maintain a gap between the two substrates 2 and 18, and they are generally located directly beneath the black layers 22 in order for them to be invisible from the outside.

In one embodiment, the electron emission display device 1000 is driven by external voltages to be applied to the cathode electrode 4, the gate electrode 8, the focusing electrode 16, and the anode electrode 24. Scan driving voltages are applied to one electrode among the cathode electrode 4 and the gate electrode 8, and thus the one electrode functions as a scanning electrode. In addition, data driving voltages are applied to the other electrode among the cathode electrode 4 and the gate electrode 8, and thus the other electrode functions as a data electrode. Voltages which are used to focus the electron beams such as 0V or negative direct voltages of several to several tens of volts are applied to the focusing electrode 16 while positive direct voltages of several hundreds to several thousands of volts are applied to the anode electrode 24 for accelerating electron beams.

Then, electric fields are formed around the electron emission unit 10 at the subpixels where the voltage difference between the cathode electrode 4 and the gate electrode 8 exceeds a threshold value, and thereby electrons are emitted therefrom. The emitted electrons are focused on a center portion of the electron beams while passing through the opening 162 of the focusing electrodes 16. They are also attracted by the high voltage applied to the anode electrode 24, and collide against the corresponding phosphor layers 20. Thus, light is emitted from the electron emission display device 1000 and then an image is displayed.

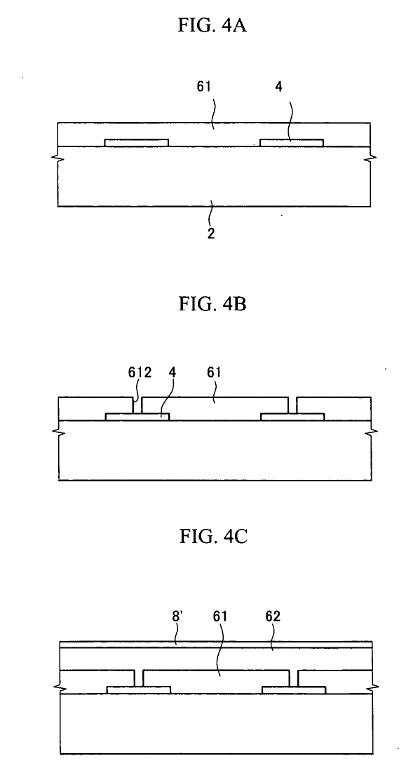

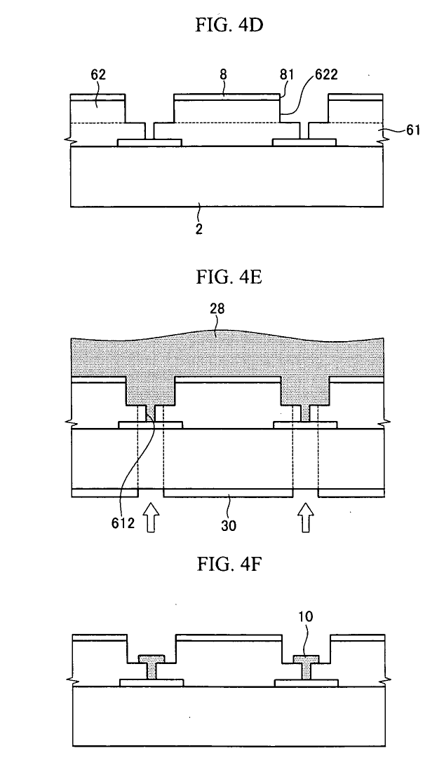

FIGS. 4A to 4F are schematic cross-section views for illustrating each step of manufacturing the electron emission device in accordance with an embodiment. The focusing electrode is omitted in FIGS. 4A to 4F for convenience.

As illustrated in FIG. 4A, a conductive layer is coated on the substrate 2. Then, the conductive layer is patterned in a stripe shape and then is formed to be a cathode electrode 4. Since the electron emission unit will be formed on the cathode electrode 4 by undergoing a process of radiating ultraviolet rays toward a rear surface of the substrate 2, the conductive layer may be made of a material that is capable of transmitting light, for example ITO.

Next, a first insulating material is printed on the entire surface of the substrate 2. Then, the first insulating material is dried and sintered. As a result, the first insulating portion 61 is formed on the substrate 2 while covering the cathode electrode 4.

Next, as illustrated in FIG. 4B, a plurality of the via holes 612 are formed in the first insulating portion 61 by using, e.g., a photo exposure method. Each via hole 612 corresponds to a cathode electrode 4.

Then, as illustrated in FIG. 4C, a second insulating portion 62 is formed on the first insulating portion 61 by, e.g., printing a second insulating material. Next, a conductive layer 8′ is coated on the second insulating portion 62.

Next, as illustrated in FIG. 4D, an opening 81 is formed in the conductive layer 8′ by using, e.g., a photo exposure method. The second insulating portion 62 is exposed to the outside through the opening 81. Then, the substrate 2 is submerged in an etching liquid and the second insulating portion 62 is etched, leaving the opening 622 in the second insulating portion 62. The conductive layer 8′ is patterned and the gate electrode 8 is formed.

In one embodiment, the first insulating portion 61 should be left as it is while the second insulating portion 62 is etched. For this, the etching rate of the first insulating portion 61 is lower than that of the second insulating portion 62. Furthermore, the etching liquid may have an etching rate that cannot etch the first insulating portion 61. In one embodiment, the etching rate is proportional to the amount of material commonly contained in the first and second insulating portions 61 and 62.

Elements contained in the first insulating portion 61 may be different from or the same as those included in the second insulating portion 62. In the latter case, the first insulating portion 61 is different from the second insulating portion 62 in composition of the elements. The first and second insulating materials may mainly include PbO and SiO₂ in addition to TiO₂ and B₂O₃. The etching rate may be controlled in proportion to an amount of B₂O₃.

Next, as illustrated in FIG. 4E, compound pastes 28 including materials for emitting electrons and photosensitive materials are coated on structures provided on the substrate 2. The via hole 612 is filled with the compound pastes 28. After a mask 30 is installed on a rear surface of the substrate 2 for photo exposure, ultraviolet rays are emitted toward the substrate 2 as indicated by arrows. Then, certain portions of the compound pastes 28 are selectively hardened.

Finally, as illustrated in FIG. 4F, other portions of the compound pastes 28, which are not hardened, are removed by development. The certain portions of the compound pastes 28 are dried and sintered, and the electron emission unit 10 is formed. Otherwise, the electron emission unit 10 may be formed by using various methods such as a direct growing method, a chemical vapor deposition (CVD) method, a sputtering method, a screen printing method, and so on.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. An electron emission device, comprising:
a substrate;
a cathode electrode located on the substrate;
an insulating layer comprising
a first insulating portion located on the substrate and covering the cathode electrode, and
a second insulating portion located on the first insulating portion and having an opening that is blocked by the first insulating portion;
a gate electrode located on the insulating layer; and
an electron emission unit located in the opening and adapted to electrically connected to the cathode electrode.

2. The device of claim 1, wherein the first insulating portion defines a via hole located below the opening, and
a conductive member is provided in the via hole such that the electron emission unit is adapted to electrically connect the cathode electrode through the conductive member.

3. The device of claim 2, wherein the electron emission unit and the conductive member are integrally formed.

4. The device of claim 2, wherein the electron emission unit includes a body portion located in the opening and a head portion extending from the body portion and located on the first insulating portion, and wherein the height of the first insulating portion is greater than that of the head portion of the electron emission unit.

5. The device of claim 2, wherein the diameter of the via hole is less than the diameter of the opening.

6. The device of claim 2, wherein the main materials of the conductive member and the electron emission unit are substantially the same.

7. The device of claim 1, wherein the electron emission unit is located on the first insulating portion.

8. The device of claim 1, wherein the etching rate of the second insulating portion is greater than etching rate of the first insulating portion.

9. The device of claim 8, wherein the etching rate is proportional to an amount of a material commonly contained in the first and second insulating portions.

10. The device of claim 9, wherein the material comprises B₂O₃.

11. The device of claim 1, wherein the distance between the electron emission unit and an imaginary plane extending from the gate electrode in a direction to be substantially parallel to the cathode electrode is substantially equal to or shorter than the distance between the cathode electrode and the electron emission unit.

12. An electron emission display device comprising:
first and second substrates opposing each other;
a cathode electrode located on the first substrate;
an insulating layer comprising
a first insulating portion located on the substrate while covering the cathode electrode, and
a second insulating portion located on the first insulating portion and having an opening that is blocked by the first insulating portion;
a gate electrode located on the insulating layer;
an electron emission unit located in the opening and adapted to electrically connect the cathode electrode;
a phosphor layer located on the second substrate; and
an anode electrode located on the second substrate.

13. The device of claim 12, wherein the first insulating portion has a via hole below the opening, and
a conductive member is provided in the via hole and contacts the electron emission unit and the cathode electrode on both sides thereof.

14. A method of manufacturing an electron emission device, comprising:
providing a cathode electrode on a substrate;
forming a first insulating layer on the substrate while covering the cathode electrode;
defining a via hole in the first insulating layer such that the cathode electrode is exposed through the via hole;
forming a second insulating layer on the first insulating layer;
forming a conductive layer on the second insulating layer;
defining an opening in the conductive layer and the second insulating layer so as to expose the via hole through the opening;
patterning the conductive layer so as to form a gate electrode;
filling the via hole with a conductive member; and
providing an electron emission unit on the first insulating layer, wherein the conductive member contacts the electron emission unit and the cathode electrode on both sides thereof.

15. The method of claim 14, wherein the opening of the second insulating layer and the via hole of the first insulating layer are provided by etching, and
an etching rate of the first insulating layer is lower than an etching rate of the second insulating layer.

16. The method of claim 15, wherein the etching rate is proportional to an amount of a material commonly contained in the first and second insulating layers.

17. The method of claim 14, wherein the electron emission unit has a cylindrical shape, wherein the diameter of the electron emission unit is greater than that of the via hole.

18. The method of claim 14, wherein the height of the first insulating layer is greater than that of a portion of the electron emission unit, and wherein the portion is located on the first insulating layer.

19. The method of claim 14, wherein the first and second insulating portions are formed by a printing method.

20. The device of claim 12, further comprising a non-self emissive display device configured to receive light which is emitted from the phosphor layer and passes through the second substrate.
